(19) United States
(12) Patent Application Publication
(10) Pub. No.: US 2020/0167776 A1
(43) Pub. Date: May 28, 2020

(54) SYSTEMS AND METHODS FOR OPTIMIZED CIPHER-BASED MESSAGE AUTHENTICATION CODE PROCESSING

(71) Applicant: MASTERCARD INTERNATIONAL INCORPORATED, Purchase, NY (US)

(72) Inventor: Mehdi Collinge, Mont-Sainte-Aldegonde (BE)

(21) Appl. No.: 16/683,414

(22) Filed: Nov. 14, 2019

Related U.S. Application Data
(60) Provisional application No. 62/772,543, filed on Nov. 28, 2018.

(51) Int. Cl. G06Q 20/38; G06Q 20/40; H04L 9/32; H04L 9/06

(52) U.S. Cl. CPC G06Q 20/38215; G06Q 20/401; G06Q 20/3829; G06Q 2220/00; H04L 9/0637; H04L 2209/56; H04L 9/3242

(57) ABSTRACT

According to some embodiments, systems, methods and computer program code are provided to generate a cipher-based message authentication code (“CMAC”) which may be used with cloud hardware security modules (“HSM”). Pursuant to some embodiments, a process for generating a CMAC includes preparing a first input set of data, issuing a first call to the HSM, the call including a key and the first input set of data, receiving an output of the first call, preparing a second input set of data, the second set including data from the output of the first call, issuing a second call to the HSM, the call including the key and the second input set of data, and receiving a cipher-based message authentication code.

### RELATED APPLICATIONS

This application is based on and claims benefit of and priority to U.S. Provisional Patent Application Ser. No. 62/772,543 filed on Nov. 28, 2018, the contents of which are hereby incorporated in their entirety for all purposes.

### BACKGROUND

The cloud computing market is expanding rapidly. More and more businesses are shifting some or all of their computing workloads to cloud services such as Amazon Web Services (“AWS”), Google Cloud Platform (“GCP”), Microsoft Azure (“Azure”) or the like. Businesses appreciate the reduced infrastructure cost and other conveniences offered by these cloud service providers. Further, cloud services allow applications to be deployed nearer to their customers, thereby reducing network latency. Cloud service providers are increasingly offering application services including security services. For example, cloud service providers offer hardware security modules (“HSM”) as a service.

As a specific example, the HSM services offered by AWS is a cloud-based HSM that allows users to generate and use their own encryption keys in the AWS cloud. The AWS HSM is a fully-managed service that automates hardware provisioning, software patching and backups, and also provides a high-availability infrastructure. These cloud HSMs may be an attractive option to businesses that wish to scale quickly with no up-front costs.

One example of a type of industry that uses HSMs is the payment industry. Many payment transactions require the use of security infrastructure including HSMs to support secure transactions. One specific example of a type of cryptographic function that is used in payment transactions is the cipher-based message authentication code (“CMAC”) such as the CMAC described in IETF RFC 4493 available at www.tools.ietf.org/html/rfc4493. Such CMAC processing can be used, for example, in payment transactions such as Mastercard Digital Secure Remote Payment (“DSRP”) transactions. Unfortunately, cloud HSMs require multiple encryption operations to perform CMAC processing which result in undesirably long transaction processing that is not necessarily compatible with the real-time needs of payment transaction processing. It would be desirable to provide optimized CMAC processing which may be performed using cloud HSMs.

### SUMMARY OF THE INVENTION

According to some embodiments, systems, methods and computer program code are provided to generate a cipher-based message authentication code (“CMAC”) which may be used with cloud hardware security modules (“HSM”). Pursuant to some embodiments, a process for generating a CMAC includes preparing a first input set of data, issuing a first call to the HSM, the call including a key and the first input set of data, receiving an output of the first call, preparing a second input set of data, the second set including data from the output of the first call, issuing a second call to the HSM, the call including the key and the second input set of data, and receiving a cipher-based message authentication code.

In some embodiments, the first input set of data includes data associated with a payment transaction. In some embodiments, the CMAC is used to authenticate the payment transaction. In some embodiments, the process is used to generate or validate an application cryptogram associated with the payment transaction. Pursuant to some embodiments, the first call to the cloud HSM is an advanced encryption standard (AES) encryption request using the cipher block chaining (CBC) mode of operation. In some embodiments, the first call to the cloud HSM causes two core AES encryption operations to occur. In some embodiments, the second call to the cloud HSM is an AES encryption request using electronic codebook (ECB) mode of operation.

A technical effect of some embodiments of the invention is an improved and optimized way for cloud HSMs to perform CMAC processing with a reduced number of calls and in a reduced amount of time, allowing cloud HSMs to support payment transactions or other transactions requiring fast response times. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system pursuant to some embodiments.

FIG. 2 is a block diagram depicting a key hierarchy associated with a prior art payment scheme.

FIG. 3 is a process diagram of a process pursuant to some embodiments.

FIG. 4 is a block diagram of an apparatus in accordance with some embodiments of the present invention.

### DETAILED DESCRIPTION

In general, and for the purpose of introducing concepts of embodiments of the present disclosure, embodiments provide systems, methods and computer program code to method to generate a cipher-based message authentication code (“CMAC”) which may be used with cloud hardware security modules (“HSM”). Pursuant to some embodiments, a process for generating a CMAC includes preparing a first input set of data, issuing a first call to the HSM, the call including a key and the first input set of data, receiving an output of the first call, preparing a second input set of data, the second set including data from the output of the first call, issuing a second call to the HSM, the call including the key and the second input set of data, and receiving a cipher-based message authentication code.

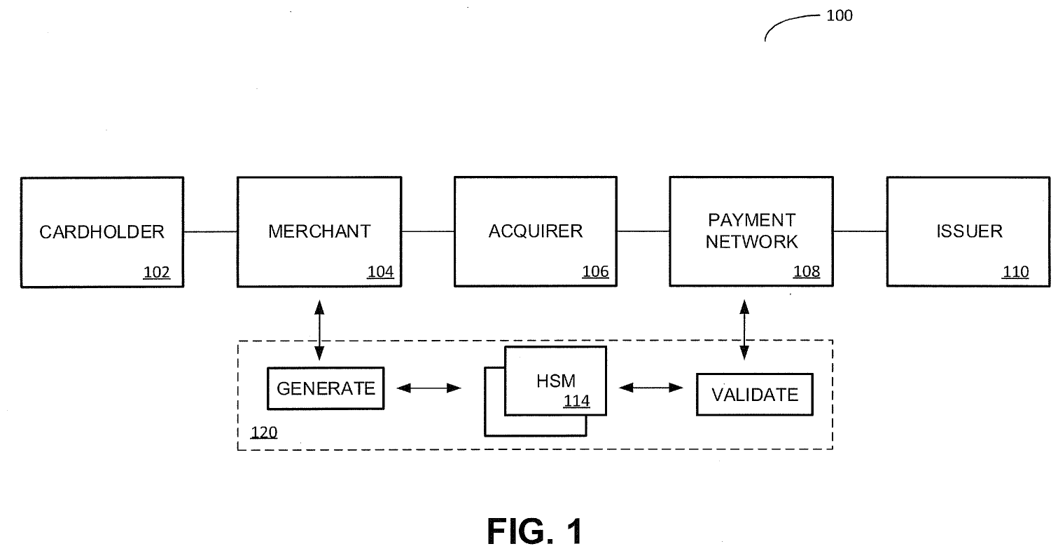

FIG. 1 is a block diagram that illustrates a system 100 in which the present invention may be applied. For illustrative purposes, features of the present invention will be described in the context of a payment transaction involving a cardholder 102 interacting with a merchant 104 using a payment device such as, for example, a payment enabled mobile device, a contactless or a contact payment card, or the like. The transaction may follow a standard four-party payment flow in which the cardholder 102 interacts with a merchant 104, and the merchant 104 transmits a payment authorization request message to an acquirer 106. The acquirer 106 interacts with a payment network 108 (such as, for example, the Banknet network operated by the assignee of the present application) to transmit the payment authorization request message to the issuer 110 associated with the payment device presented by the cardholder 102 in the transaction.

In general, the transaction will be described as one involving payment cards configured pursuant to the specifications promulgated by EMVCo and available at http://www.emvco.com. Those skilled in the art, upon reading the present disclosure will appreciate that features of the present invention may be used with desirable results in other types of transactions and in transactions involving other types of devices.

As shown, the system 100 further includes a merchant 104 in communication with the cardholder 102. Although only a single cardholder 102 and merchant 104 are depicted, the system 100 likely involves a multitude of both devices or entities. For example, a number of cardholders (using a number of payment devices) may interact with a variety of different merchants 104 to facilitate transactions pursuant to the present invention. An interaction between a cardholder 102 and a merchant 104 may be, for example, a remote interaction such as, for example, a wireless interaction over a network interface. For example, the cardholder 102 may operate a mobile device to interact with the merchant 104 to conduct a purchase transaction over a communication network using a protocol such as HTTP (HyperText Transfer Protocol) or the like. In some embodiments, the communication between the cardholder 102 and the merchant 104 may be facilitated or controlled via a mobile application installed on a mobile device (e.g., such as, for example, a merchant application on the mobile device).

Pursuant to some embodiments, transactions are processed using a secure payment protocol which may be referred to herein as the Digital Secure Remote Payment (“DSRP”) protocol which provides improved fraud prevention (which, in some embodiments, may allow reduced fraud liability for the merchant). Transactions involving the DSRP protocol require cryptographic processing support. As shown in FIG. 1, some or all of the cryptographic processing support may be provided by one or more payment services 120. The payment services 120 may be accessible to merchants 104, the payment network 108 and other entities in the payment system that need cryptographic and other support services, and may be accessible via, for example, a secured application programming interface (API) or the like. For example, the merchant 104 may interact with the payment services 120 to obtain generated transaction credentials that can then be used in conjunction with the authorization request transmitted to the acquirer 106.

Pursuant to the present invention, the payment services 120 may include (or be in communication with) one or more cloud HSMs 114 configured to operate as described further herein. For example, in some embodiments, the function to generate transaction credentials (on request from the merchant 104) may be operated in the cloud as a payment service 120 and will further interact with one or more cloud HSMs 114 to secure the process and perform cryptographic operations. For example, in a DSRP transaction, there are Application Cryptogram (“AC”) generation and validation steps during a transaction. Each AC generation or AC validation requires the generation of two cryptograms. Pursuant to the present invention, the cloud HSM 114 is used to generate those cryptograms as will be discussed further herein.

When the generated transaction credentials are provided to the merchant 104, the merchant provides those credentials along with other transaction information to the acquirer 106 in conjunction with a payment authorization request message. The acquirer 106 routes the authorization request message via a payment network 108 for further processing and for delivery to the issuer 110 (or to an agent of the issuer 110).

The payment network 108 may interact with the payment services 120 to validate the transaction credentials received in conjunction with the authorization request message. The validation of transaction credentials may be performed as a service using one or more cloud HSMs 114 which are used to secure the process and perform cryptographic operations. Once the payment network 108 has validated the transaction credentials, the payment network 108 may route the authorization request message to the issuer 110 associated with the payment card used in the transaction for authorization. In prior transaction processing architectures, the generation and validation of transaction credentials were performed using non-cloud based HSMs as described elsewhere herein.

Pursuant to the present invention, some of the cryptographic processing support may be provided by one or more security modules in a cloud computing environment (e.g., such as the cloud HSM 114). The cloud HSM 114 may be provided by, for example, a cloud service provider such as AWS, GCP or Azure. Although only a single cloud HSM 114 is shown, those skilled in the art, upon reading the present disclosure, will appreciate that a number of cloud HSMs 114 may be provided to support a number of transactions. For example, in some embodiments, a cluster of cloud HSMs 114 may be provided in one or more geographical regions to provide high availability and redundant operation sized to accommodate the expected number of transactions.

The components of the system 100 as depicted in FIG. 1 are only those that are needed for processing a single transaction. A typical practical embodiment of the system 100 may process many purchase transactions (including simultaneous transactions) and may include a considerable number of payment card issuers and their computers, a considerable number of acquirers and their computers, and numerous merchants and their merchant servers and associated components. The system may also include a very large number of payment cardholders, who carry payment-enabled mobile devices and/or payment cards (including contactless payment cards).

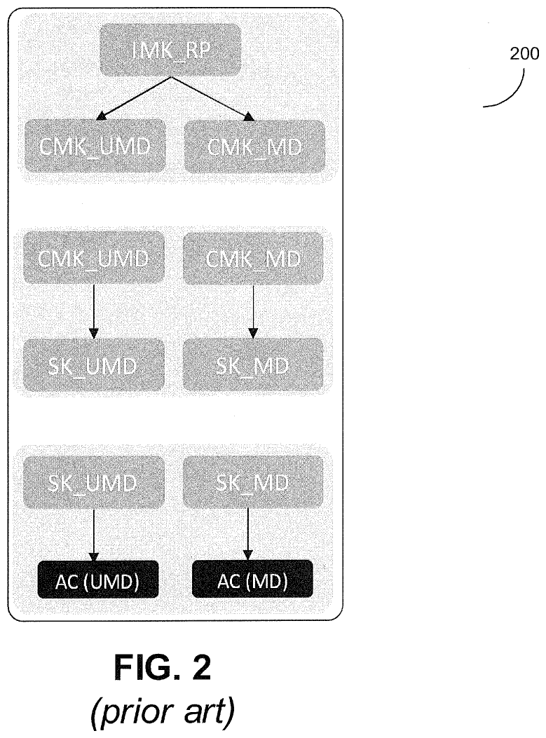

Features of some embodiments will now be described by reference to an existing remote payment scheme compliant with the EMV specifications that commonly uses specially configured hardware security modules. In particular, the payment scheme is the DSRP protocol referenced above. DSRP can use a cryptographic key hierarchy 200 as shown in FIG. 2. The Issuer Master Key (IMK) can be used to derive two Card Master Keys (CMK), CMK_UMD and CMK_MD where (1) the Mobile Device Authentication key is referenced as “MD” key, and (2) the User and Mobile Device Authentication key is referenced as “UMD” key. In general, in a DSRP environment, the derivation process is the same for both keys and the difference between the keys is at the level of the input data.

Further, Each Card Master Key (CMK_xx) can be derived to generate Session Keys (SK_xx). In a simplified view, to some extent, the derivation process for the session keys (SK_xx) can be considered as similar (from a core crypto function point of view) to the derivation process used for CMK_xx derivation where the difference between the session keys is at the level of the input data. Further details of key management in the DSRP protocol can be found in the EMV specifications referenced above. In the following discussion, the details are summarized.

First, for the Card Master Keys (CMKs), the notation IMK_xx and CMKxx_yyy is adopted for reference herein, where “xx” denotes RP (Remote Payment) and yyy can be user and mobile device (UMD) or mobile device (MD). Next, the Card Master Keys can be generated using the Advanced Encryption Standard (AES) as described herein. First, the Card Master Keys CMK_xx_yyy are derived using a process that corresponds to Option C defined in Annex A1.4.3 of Book 2 of the EMV4.3 Specifications. In particular, the Card Master Key CMK_xx_yyy is derived from the corresponding Issuer Master Key IMK_xx as follows: CMK=AES(IMK_xx)[Y], where (i) AES is a 128-bit AES Encryption using electronic codebook (“ECB”) mode and (ii) Y is a 16-byte value.

Next, the Session Keys (SKs) are also generated using AES. For example, the SKs are derived from corresponding Card Master Keys as described in Annex A1.3 of Book 2 of EMV4.3 for a 16-byte block cipher. The Session Keys SKRP_yyy are derived from the Card Master Keys CMK_RP_yyy where yyy can be UMD or MD. A session key (SK) is derived from the corresponding Card Master Key (CMK) in conjunction with the Application Transaction Counter (ATC, a 2-byte hexadecimal value that is unique to the transaction) as follows: SK=AES (CMK) [ATC∥ ‘00’ ∥ ‘00’ ∥ ‘00’ ∥ ‘00’ ∥ ‘00’ ∥ ‘00’ ∥ ‘00’ ∥ ‘00’ ∥ ‘00’ ∥ ‘00’ ∥ ‘00’ ∥ ‘00’∥ ‘00’∥ ‘00’] where AES is a 128-bit AES Encryption using ECB mode.

Now that the key generation process has been shown, the general process to generate an Application Cryptogram (“AC”) for DSRP DE48SE43 (UCAF) will be described. First, the generation of AC_RP_UMD and AC_RP_MD requires access to crypto functions as follows. First, create a buffer (39 bytes): buffer=dsrpAmountAuthorized (6 bytes)∥dsrpAmountOther (6 bytes)∥dsrpTerminalCountryCode (2 bytes)∥dsrpTVR (5 bytes)∥dsrpTransactionCurrencyCode (2 bytes)∥dsrpTransactionDate (3 bytes)∥dsrpTransactionType (1 byte)∥dsrpUN (4 bytes)∥dsrpAIP (2 bytes)∥dsrpATC (2 bytes)∥dsrpCVR (6 bytes).

Next, the Application Cryptograms (ACs) are generated using a cryptographic computation using the buffer, a padding process and the session keys (SKRP_UMD and SK_RP_MD) as follows: (i) AC_RP_UMD=MAC(SK_RP_UMD)[buffer] and (ii) AC_RP_MD=MAC(SK_RP_MD)[buffer]

The values AC_RP_UMD and AC_RP_MD must be integrated in the template defined for UCAF using proprietary UCAF Format 0 defined by Mastercard (dsrpUCAFFormat0) using an Application Cryptogram (AC) data object (8 bytes) constructed using: (i) the leftmost 4 bytes of the AC data object are equal to Byte [1-4] of AC_RP_MD, and (ii) the rightmost 4 bytes of the AC data object are equal to Byte [5-8] of the AC_RP_UMD.

When using AES to generate the AC, the padding is done using ‘80’ followed by ‘00’ to create a multiple of 16 bytes. The computation of an s-byte MAC (4≤s≤16) is according to ISO/IEC 9797-1 Algorithm 5 (CMAC) using a 128-bit (16 byte) block cipher algorithm (AES) in Cipher Block Chaining (“CBC”) mode and using a k-bit key Kmac where k=128, 192, or 256. When validating (in DSRP), the cryptographic process is similar to the generation. Instead of delivering the application cryptograms (ACs) the function is expected to check the values against the supplied ACs.

With the above background, a brief discussion of disadvantages of using the existing CMAC process using cloud HSMs will now be provided. In a standard implementation of CMAC (pursuant to the above-referenced RFC 4493), four different encryption calls must be made to a cloud HSM (e.g., such as the cloud HSM provided by AWS as an example). The four calls proceed as follows. First, the key is loaded. Next, sub keys (K1 and K2) are generated. Then, the input data is prepared for the first AES call using 0's. A first AES call to the cloud HSM is made with 1 core AES encryption operation. Next, the CMAC is computed, and a second AES call is made to the cloud HSM using a portion of the input data (M_1) and 0's. A third AES call is then made to the cloud HSM using a second portion of the input data (M_2) and the output of the second AES call. A fourth AES call is then made to the cloud HSM using a third portion of the input data (M_3), K1 and the output of the third AES call. Finally, the key is unloaded and the process completes. Unfortunately, when the above steps are implemented on a cloud HSM, the overall process takes an unreasonably long time (longer than is desirable for payment transaction support). Further, the process does not scale well—and an undesirably large quantity of cloud HSM resources are required to support a large number of concurrent payment transactions.

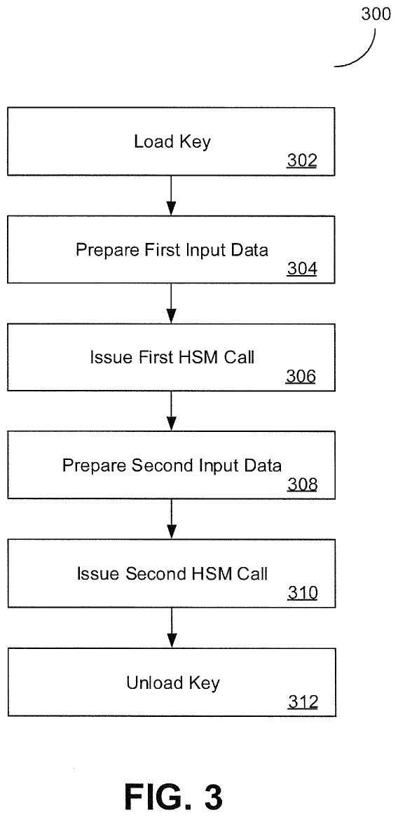

Reference is now made to FIG. 3 where a flow diagram depicting an optimized cipher-based message authentication code process 300 pursuant to the present invention is shown. The process 300 reduces the time required to perform CMAC processing by a factor of two (2) or more and allows a larger number of concurrent transactions to be supported by a reduced quantity of cloud HSM 114 resources. As discussed above, prior CMAC processing approaches require four (4) AES encryption operation calls to a cloud HSM. Pursuant to the present invention, the process 300 only requires two (2) cloud HSM 114 calls. The process 300 begins at 302 where the key is loaded. For example, the key may be loaded into a Java application associated with (or in communication with) the cloud HSM 114 (or the cloud HSM cluster). The input data (“M”) is then prepared for processing. The input data is 48 bytes, and the leftmost 16 bytes (“M_1”) are set to 0s and the remaining 32 bytes broken into two blocks (“M_2” and “M_3”) of sixteen bytes each.

Processing at 304 includes preparing the first input data using M_1 (which consists of the sixteen leftmost bytes and are set to 0s) and M_2 (the second block of sixteen bytes from the input data “M”). At 306, the first cloud HSM 114 call is issued. Pursuant to the present invention, the first call includes two (2) core AES encryption operations to be performed by the cloud HSM 114. Pursuant to some embodiments, the first call uses AES in CBC mode of operation. The first call uses M_1 (which consists of 0s) in the first input data, thereby the leftmost 16 bytes of the output or response from the first call is then used as the input for generating key K1 (there is no need to generate any K2). The rightmost 16 bytes of the output is used as an input for the second HSM call.

Processing continues at 308 where the second input data is prepared. As discussed above, the second input data uses M_3 (the third 16 bytes block from the input data “M”), the generated K1 and the rightmost 16 bytes from the output of the first HSM call. A second HSM call is issued at 310. Pursuant to some embodiments, the second HSM call is one core AES encryption request using ECB mode. In the event that the HSM does not support ECB mode of operation, CBC mode may be used (with the input value set to 0s).

The response is received and key is unloaded at 312 to complete the optimized CMAC process. While this process 300 has been described at a relatively high level, further details will be provided below with a detailed description of an optimized CMAC generation process.

First, however, a description (with sample data) of cryptogram generation for DSRP (carried in the transaction flow using data element 48 and subelement 43 in ISO 8583 message—generally referred to as the UCAF field) will be provided. The process for validation is similar and will not be described in detail herein. The Universal Cardholder Authentication Field (“UCAF”) is a standard, globally interoperable method of collecting cardholder authentication data at the point of interaction across all channels including the Internet and mobile devices. In the payment networks, UCAF is a universal, multi-purpose data transport infrastructure that is used to communicate authentication information. In most UCAF implementations, the UCAF carries application-specific data that can be coded using base 64 using a variable length field up to a maximum of 32 positions. In the optimized CMAC process of the present invention, the UCAF data (as well as other data elements associated with the transaction) are used.

First, the following data elements (and corresponding sample values for illustration) from a card profile are used: (i) primary account number (“PAN”) Sequence Number (1 byte): dsrpPSN=00, (ii) Application Interchange Profile (“AIP”) (2 bytes): dsrpAIP=1A00, (iii) Key Derivation Index (KDI) (1 byte): dsrpKDI=03, (iv) Cryptogram Version Number (CVN) (1 byte): dsrpCVN=33. Note that the value of 33 used for the CVN is an arbitrary value that may be changed.

Next, the following static values are used for UCAF Format 0: (i) DSRP UCAF Version (1 nibble): dsrpUCAFVersion=0000b, (ii) Amount, Authorized (Numeric) (6 bytes): dsrpAmountAuthorized=000000000000, (iii) Amount, Other (Numeric) (6 bytes): dsrpAmountOther=000000000000, (iv) Terminal Country Code (2 bytes): dsrpTerminalCountryCode=0000, (v) Transaction Currency Code (2 bytes): dsrpTransactionCurrencyCode=0000, (vi) Transaction Date (3 bytes): dsrpTransactionDate=000000, (vii) Transaction Type (1 byte): dsrpTransactionType=00, and (viii) Card Verification Results (6 bytes): dsrpCVR=A50000000000.

Next, the following transaction related information are used: Unpredictable Number (4 bytes): dsrpUN=45AC6F28 where 45AC6F28 is a random 4-byte value generated for the transaction.

Based on these data elements, the following optimized CMAC process pursuant to the present invention may be followed. First, the key is loaded at 302. Next, the input data is prepared. The input data may be prepared by constructing a buffer that contains the following data: dsrpAmountAuthorized∥dsrpAmountOther∥dsrpTerminalCountryCode∥dsrpTVR∥dsrpTransactionCurrencyCode∥dsrpTransactionDate∥dsrpTransactionType∥dsrpUN∥dsrpAIP∥dsrpATC∥dsrpCVR

Next, the buffer is padded using 0x80 followed by 0x00 in order to create a 48 bytes padded buffer. A first AES call is made to the cloud HSM to perform AES CBC encryption using the AES key (16 bytes) and the 32 leftmost bytes of the padded buffer and IV set to 0s (16 bytes). Next, the variable “L” is defined as the leftmost 16 bytes of the output of AES CBC encryption and it is then used for K1 generation. IF the most-significant bit (MSB) of L is equal to 0, THEN K1:=L<<1, ELSE K1:=(L<<1) XOR 0x00000000000000000000000000000087.

Next, a temporary buffer (tempBuffer) is created using: (i) R as the rightmost 16 bytes of the output of AES CBC encryption, (ii) K1 (as computed above), and (iii) M as the 16 rightmost bytes of the padded buffer. The tempBuffer is set to equal: R XOR K1 XOR M. Next, AES ECB encryption is performed using the key (16 bytes) and tempBuffer (16 bytes) to generate the CMAC value. As discussed above, if AES ECB is not supported, AES CBC can be used with an IV set to 0s (16 bytes).

In general, the optimized process pursuant to the present invention reduces the number of cryptographic calls that need to be made to an HSM, making it possible to use cloud HSMs 114 for the generation and verification of cryptograms in transactions such as those described herein. Details of two illustrative examples will now be provided which include sample transaction data (with the first example shown in TABLE I and the second example shown in TABLE II). In each example, it is shown that only two HSM calls are required to perform generation or verification processing.

TABLE I

| Context | Details |
|---|---|
| Input | D = PAN \|\| PSN = 523818800000102000 |
| Data / | IMK_RP = 381698C479CEE58FD675A4255D07AD89 |
| Assump- | CMK_RP_UMD = AES |
| tions | (IMK_RP) |
| | B00C4938557F05F7BFCF28BDC0284989 |
| | ATC = 0003 |
| | SK_RP_UMD = AES (CMK_RP_UMD) |
| | [00030000000000000000000000000000] = |
| | AC26D14535B0D44B534A26C2107A2CD9 |
| | Input for AC generation = |
| | 0000000000000000000000000000000000000000000000000045AC6F281A000 |
| | 003A50000000000800000000000000000 |
| First | We create a message using: |
| Call | M_1 = 00000000000000000000000000000000 |
| (AES | M_2 = 00000000000000000045AC6F281A0000 |
| CBC) | M = |
| | 0000000000000000000000000000000000000000000000000045AC6F281A000 |
| | 0 |
| | [AES Call #1] Use AES CBC with: |
| | Data = |
| | 0000000000000000000000000000000000000000000000000045AC6F281A000 |
| | 0 |
| | Key = AC26D14535B0D44B534A26C2107A2CD9 |
| | IV = 00000000000000000000000000000000 |
| | AES(Data) = |
| | 3F08E05FAA30CBD9A5FD6674FD8213C220215AE086F701CBE02DC5C10 |
| | D863063 |
| | We use the leftmost 16 bytes as input for K1 generation |
| | L = 3F08E05FAA30CBD9A5FD6674FD8213C2 |
| | 3F ->0011 FFFF |
| | MSB(L) is equal to 0 |
| | => K1 := (L << 1) |
| | K1 = L << 1 = 7E11C0BF546197B34BFACCE9FB042784 |
| | There is no need to generate K2 as it is not used. |
| | We use the rightmost 16 bytes as input (“AES(Data_M_2)” = |
| | 20215AE086F701CBE02DC5C10D863063) to prepare data for the second |
| | AES call. |
| Second | M_3 = 03A50000000000800000000000000000 |
| Call | M_3 XOR K1 = 7DB4C0BF546197334BFACCE9FB042784 |
| (AES | “AES(Data_M_2)” = 20215AE086F701CBE02DC5C10D863063 |
| ECB) | [AES Call #2] Use AES ECB with: |
| | Data = (M3_XOR K1) XOR “AES(Data_M_2)” |
| | Data = 5D959A5FD29696F8ABD70928F68217E7 |
| | Key = AC26D14535B0D44B534A26C2107A2CD9 |
| | AES(Data) = 0FB1881DDCC2CDE5E0E0AD2E8D205444 |

TABLE II

| Context | Details |
|---|---|
| Input | This sample uses: |
| Data/ | D = PAN \|\| PSN = 523818800000102000 |
| Assump- | IMK_RP = 381698C479CEE58FD675A4255D07AD89 |
| tions | CMK_RP_UMD = AES |
| | (IMK_RP)[00000000000000523818800000102000] = |
| | B00C4938557F05F7BFCF28BDC0284989 |
| | ATC = 0005 |
| | SK_RP_UMD = AES (CMK_RP_UMD) |
| | [00050000000000000000000000000000] = |
| | ED8F72CCE0D42AE39A5797D9A20F8822 |
| | Input for AC generation = |
| | 0000000000000000000000000000000000000000000000000045AC6F281A000 |
| | 005A50000000000800000000000000000 |
| First | We create a message using: |
| Call | M_1 = 00000000000000000000000000000000 |
| (AES | M_2 = 00000000000000000045AC6F281A0000 |
| CBC) | M = |
| | 0000000000000000000000000000000000000000000000000045AC6F281A000 |
| | 0 |
| | [AES Call #1] Use AES CBC with: |
| | Data = |
| | 0000000000000000000000000000000000000000000000000045AC6F281A000 |
| | 0 |
| | Key = ED8F72CCE0D42AE39A5797D9A20F8822 |
| | IV = 00000000000000000000000000000000 |
| | AES(Data) = |
| | F06633DEFB42BDBFF4F0BCF21A8E572E31D6FF96FEA6BDE3415D9EB1 |
| | AE52DACF |
| | We use the leftmost 16 bytes as input for K1 generation |
| | L = F06633DEFB42BDBFF4F0BCF21A8E572E |
| | F0 -> 1111 0000 |
| | MSB(L) is NOT equal to 0 |
| | [0043] = > K1 := (L << 1) XOR |
| | 0x00000000000000000000000000000087 |
| | [0044] L << 1 = E0CC67BDF6857B7FE9E179E4351CAE5C |
| | [0045] K1 = (L << 1) XOR |
| | 00000000000000000000000000000087 = |
| | E0CC67BDF6857B7FE9E179E4351CAEDB |
| | [0046] There is no need to generate K2 as it is not used. |
| | We use the rightmost 16 bytes as input “AES(Data_M_2)” = |
| | 31D6FF96FEA6BDE3415D9EB1AE52DACF) to prepare data for the second |
| | AES call. |
| Second | M_3 = 05A50000000000800000000000000000 |
| Call | M_3 XOR K1 =E56967BDF6857BFFE9E179E4351CAEDB |
| (AES | “AES(Data_M_2)” = 31D6FF96FEA6BDE3415D9EB1AE52DACF |
| ECB) | [AES Call #2] Use AES ECB with: |
| | Data = (M_3 XOR K1) XOR “AES(Data_M_2)” |
| | Data = D4BF982B0823C61CA8BCE7559B4E7414 |
| | Key = ED8F72CCE0D42AE39A5797D9A20F8822 |
| | AES(Data) = 9AAE56C1C9D200C231D236BF62F46F82 |

The flow charts and transaction flows described herein do not imply a fixed order to the steps, and embodiments of the present invention may be practiced in any order that is practicable. Although some figures use numbers to indicate a sequence of steps, those steps are illustrative and may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The embodiments described herein may be implemented using any number of different hardware configurations. Embodiments described herein may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

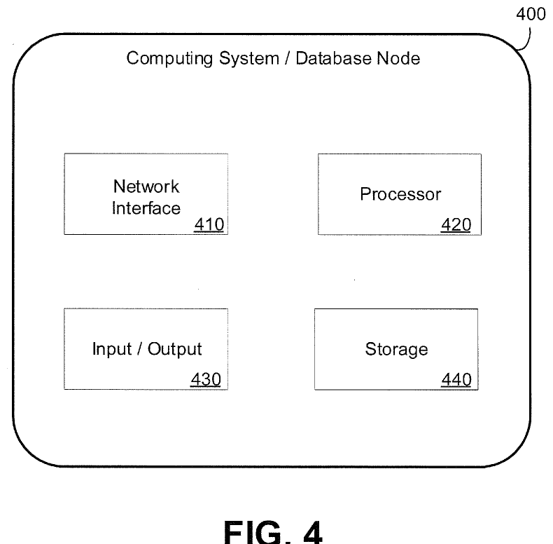

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 4 illustrates an example computing system 400 which may represent or be integrated in any of the above-described components (such as, for example, the payment server 104, the merchant server 106, the device 102, etc.). FIG. 4 is not intended to suggest any limitation as to the scope of use or functionality of embodiments described herein. The computing system 400 is capable of being implemented and/or performing any of the functionality set forth hereinabove.

The computing system 400 may include a computer system/server, which is operational with numerous other general-purpose or special purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like.

The computing system 400 may be described in the general context of computer system-executable instructions, such as program modules, being executed by a computer system. Generally, program modules may include routines, programs, objects, components, logic, data structures, and so on that perform particular tasks or implement particular abstract data types. The computing system 400 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 4, the computing system 400 is shown in the form of a general-purpose computing device. The components of computing system 400 may include, but are not limited to, a network interface 410, one or more processors or processing units 420, an output 430 which may include a port, an interface, etc., or other hardware, for outputting a data signal to another device such as a display, a printer, etc., and a storage device 440 which may include a system memory, or the like. Although not shown, the computing system 400 may also include a system bus that couples various system components including system memory to the processor 420.

The storage device 440 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 440 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 440 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 400 may also communicate with one or more external devices such as a keyboard, a pointing device, a display, etc.; one or more devices that enable a user to interact with computer system/server; and/or any devices (e.g., network card, modem, etc.) that enable computing system 400 to communicate with one or more other computing devices. Such communication can occur via I/O interfaces. Further, computing system 400 can communicate with one or more networks such as a local area network (LAN), a general wide area network (WAN), and/or a public network (e.g., the Internet) via network interface 410. As depicted, network interface 410 may also include a network adapter that communicates with the other components of computing system 400 via a bus. Although not shown, other hardware and/or software components could be used in conjunction with the computing system 400. Examples include, but are not limited to: microcode, device drivers, redundant processing units, external disk drive arrays, RAID systems, tape drives, and data archival storage systems, etc.

Pursuant to some embodiments, the computing system 400 may be a user device (e.g., such as a mobile phone, tablet computer, personal computer or the like) operated by a user to display from a merchant website during a purchase transaction involving the secure remote commerce system of the present invention.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A computer-implemented method to generate a cipher-based message authentication code, the method comprising:
preparing a first input set of data;
issuing a first call to a cloud hardware security module (HSM), the call including a key and the first input set of data;
receiving an output of the first call;
preparing a second input set of data, the second set including data from the output of the first call;
issuing a second call to the cloud HSM, the call including the key and the second input set of data; and
receiving a cipher-based message authentication code.

2. The computer-implemented method of claim 1, wherein the first input set of data includes data associated with a payment transaction.

3. The computer-implemented method of claim 2, wherein the data associated with a payment transaction includes at least one of data associated with a transaction amount, a currency code, a transaction date, an unpredictable number, a transaction type, and a card verification result.

4. The computer-implemented method of claim 2, wherein the cipher-based message authentication code is used to authenticate the payment transaction.

5. The computer-implemented method of claim 2, wherein the cipher-based message authentication code is used to generate an application cryptogram associated with the payment transaction.

6. The computer-implemented method of claim 2, wherein the cipher-based message authentication code is used to validate an application cryptogram associated with the payment transaction.

7. The computer-implemented method of claim 1, wherein the first call to the cloud HSM is an advanced encryption standard (AES) encryption request using the cipher block chaining (CBC) mode of operation.

8. The computer-implemented method of claim 7, wherein the first call to the cloud HSM causes two core AES encryption operations to occur.

9. The computer-implemented method of claim 1, wherein the second call to the cloud HSM is an AES encryption request using at least one of electronic codebook (ECB) mode of operation and cipher block chaining (CBC) mode of operation.

10. A system to generate a cipher-based message authentication code, comprising:
a first communication port to exchange information associated with a remote hardware security module (HSM);
a processing system, coupled to the first communication port, including a computer processor a memory storing instructions to cause the computer processor to:
prepare a first input set of data;
issue a first call to the HSM, the call including a key and the first input set of data;
receive an output of the first call;
prepare a second input set of data, the second set including data from the output of the first call;
issue a second call to the HSM, the call including the key and the second input set of data; and
receive a cipher-based message authentication code.

11. The system of claim 10, wherein the first input set of data includes data associated with a payment transaction.

12. The system of claim 11, wherein the cipher-based message authentication code is used to authenticate the payment transaction.

13. The system of claim 10, wherein the first call to the cloud HSM is an advanced encryption standard (AES) encryption request using the cipher block chaining (CBC) mode of operation.

14. The system of claim 10, wherein the first call to the cloud HSM causes two core AES encryption operations to occur.

15. The system of claim 10, wherein the second call to the cloud HSM is an AES encryption request using at least one of electronic codebook (ECB) mode of operation and cipher block chaining (CBC) mode of operation.

16. A non-tangible, computer-readable medium storing instructions, that, when executed by a processor, cause the processor to perform a method to generate a cipher-based message authentication code, the method comprising:
preparing a first input set of data;
issuing a first call to a cloud hardware security module (HSM), the call including a key and the first input set of data;
receiving an output of the first call;
preparing a second input set of data, the second set including data from the output of the first call;
issuing a second call to the cloud HSM, the call including the key and the second input set of data; and
receiving a cipher-based message authentication code.
